(19) United States
(12) Patent Application Publication
(10) Pub. No.: US 2026/0162196 A1
(43) Pub. Date: Jun. 11, 2026

(54) AUTOMATED TRACKING OF ASSET CONDITIONS OVER TIME

(71) Applicant: MCR HOTELS, New York, NY (US)

(72) Inventors: Tyler Morse, New York, NY (US); Eric Ruvio, New York, NY (US); Kyle MCCAIG, New York, NY (US)

(21) Appl. No.: 18/976,049

(22) Filed: Dec. 10, 2024

(51) Int. Cl. G06Q 50/12; G06Q 10/20; G06Q 40/12

(52) U.S. Cl. CPC G06Q 50/12; G06Q 10/20; G06Q 40/12

(57) ABSTRACT

The system and method may utilize artificial intelligence to analyze data and push key information to authorities who have the ability to act on the summarized data.

### BACKGROUND

Maintaining an asset such as a hotel or a series of hotels may be challenging. Changes in demand, physical structure, and local markets may add to the complexity. The sheer volume of data and information related to these assets may quickly become overwhelming. Additionally, some of the data may have been previously reported, leading to potential redundancy. Finally, certain types of data, like financial information, may be especially critical and require immediate attention. However, if this data goes unnoticed, it may not be acted upon.

### SUMMARY

The system and method may utilize artificial intelligence to analyze data and push key information to authorities who have the ability to act on the summarized data. In one aspect, data may be gathered about elements in a plurality of physical facilities, stored in memory, and a baseline established for each element. The data related to each element of the physical facilities may then be analyzed. The system and method may determine if the data for any element exceeds a threshold in comparison to its baseline. If the data for an element exceeds the threshold, it may be added to a display, and the communication of the display may be initiated to desired users.

In a second aspect, a method of tracking communications regarding elements of an asset may be disclosed. The system and method may receive a communication regarding an element of an asset, add it to a database, and analyze it to determine the elements involved. The system and method may determine if there are issues with the elements in the communication, add the elements to a database, and if an element requires service, format the details into a protocol and communicate them to a service provider according to an API. The element details may be added to a database, periodically collected into a report, and communicated to an authority.

In a third aspect, a computerized method of tracking the conditions of physical assets may be disclosed. The system and method may establish a baseline condition for elements of the physical assets and receive updated condition indications after a period of time. The system and method may determine if the updated conditions are materially different from the baseline. If the updated condition of an element is determined to be materially different, it may be added to a report. Conversely, if the updated condition is not materially different, it may not be added to the report. The report may then be displayed to a supervisor.

### BRIEF DESCRIPTION OF THE DRAWINGS

FIG. 1 is a flowchart illustrating an aspect of the system and method;

FIG. 2 is a flowchart illustrating an aspect of the system and method;

FIG. 3 is a flowchart illustrating an aspect of the system and method;

FIG. 4 is an illustration of an artificial intelligence system;

FIG. 5 is an illustration of an artificial intelligence system;

FIG. 6 is an illustration of an artificial intelligence system;

FIG. 7 is an illustration of a sample computing system;

FIG. 8 is an illustration of a report on an asset;

FIG. 9 is an illustration of a report on an asset;

FIG. 10 is an illustration of a report on an asset;

FIG. 11 is an illustration of a report on an asset;

FIG. 12 is an illustration of a report on an asset;

FIG. 13 is an illustration of a report on an asset;

FIG. 14 is an illustration of a report on an asset;

FIG. 15 is an illustration of a report on an asset;

FIG. 16 is an illustration of a report on an asset;

FIG. 17 is an illustration of a report on an asset;

FIG. 18 is an illustration of a report on an asset;

FIG. 19 is an illustration of a report on an asset;

FIG. 20 is an illustration of a report on an asset;

FIG. 21 is an illustration of a report on an asset;

FIG. 22 is an illustration of a report on an asset;

FIG. 23 is an illustration of a report on an asset;

FIG. 24 is an illustration of a report on an asset;

FIG. 25 is an illustration of a report on an asset;

FIG. 26 is an illustration of a report on an asset;

FIG. 27 is an illustration of a report on an asset;

FIG. 28 is an illustration of a report on an asset;

FIG. 29 is an illustration of a report on an asset;

### SPECIFICATION

Persons of ordinary skill in the art will appreciate that the elements in the figures are illustrated for simplicity and clarity, so not all connections and options have been shown to avoid obscuring the inventive aspects. For example, common but well-understood elements that are useful or necessary in a commercially feasible embodiment are often not depicted to provide a less obstructed view of these various embodiments. It will also be appreciated that certain actions and/or steps may be described or depicted in a particular order of occurrence, although those skilled in the art will understand that such specificity with respect to sequence is not required. The terms and expressions used herein are to be defined with respect to their corresponding areas of inquiry and study, except where specific meanings have been set forth herein. All dimensions specified in this disclosure may be by way of example only and are not intended to be limiting. Furthermore, the proportions shown in these figures may not necessarily be to scale. As will be understood, the actual dimensions and proportions of any system, device, or part disclosed herein may be determined by its intended use.

The system and method address the technical problem of how to design a computer system to automatically collect and forward information determined to be relevant in an easy-to-read and understandable format, enabling prompt decision-making based on the information. The technical solution creates a practical application in the form of a user interface that represents a significant advancement over current systems. It is more than just a data collection system; it requires intelligence, detailed analysis, multi-variable based determinations, and speed beyond human capabilities.

Methods and devices that may implement the embodiments of the various features of the invention will now be described with reference to the drawings. The drawings and associated descriptions are provided to illustrate embodiments of the invention and not to limit its scope. References in the specification to “one embodiment” or “an embodiment” indicate that a particular feature, structure, or characteristic described in connection with that embodiment may be included in at least one embodiment of the invention. The appearance of the phrase “in one embodiment” or “an embodiment” in various places in the specification does not necessarily refer to the same embodiment.

Throughout the drawings, reference numbers may be re-used to indicate correspondence between referenced elements. As used in this disclosure, except where the context requires otherwise, the term “comprise” and its variations, such as “comprising,” “comprises,” and “comprised,” are not intended to exclude other additives, components, integers, or steps.

In the following description, specific details are provided to give a thorough understanding of the embodiments. However, it is understood by those of ordinary skill in the art that the embodiments may be practiced without these specific details. Well-known circuits, structures, and techniques are not shown in detail to avoid obscuring the embodiments. For example, circuits may be shown in block diagrams to avoid unnecessary detail.

The embodiments may be described as a process depicted as a flowchart, flow diagram, structure diagram, or block diagram. The flowcharts and block diagrams in the figures illustrate the architecture, functionality, and operation of possible implementations of systems, methods, and computer programs according to various embodiments disclosed herein. Each block in the flowcharts or block diagrams may represent a module, segment, or portion of code that includes one or more executable instructions for implementing the specified logical function(s). It should be noted that in some alternative implementations, the functions noted in the blocks may occur in a different order than noted in the figures.

Although a flowchart may describe operations as a sequential process, many of the operations may be performed in parallel or concurrently. In addition, the order of operations may be rearranged. A process may be terminated when its operations are completed. A process may correspond to a method, function, procedure, subroutine, subprogram, etc. When a process corresponds to a function, its termination may correspond to the return of the function to the calling function or the main function. Additionally, each block in the block diagrams and/or flowchart illustrations, and combinations of blocks in the block diagrams and/or flowchart illustrations, may be implemented by special-purpose hardware-based systems that perform the specified functions or acts, or by combinations of special-purpose hardware and computer instructions.

A storage device may represent one or more devices for storing data, including read-only memory (ROM), random access memory (RAM), magnetic disk storage media, optical storage media, flash memory devices, and/or other non-transitory machine-readable media for storing information. The term “machine-readable medium” includes, but is not limited to, portable or fixed storage devices, optical storage devices, wireless channels, and various other non-transitory media capable of storing, comprising, containing, executing, or carrying instructions and/or data.

Embodiments may be implemented in hardware, software, firmware, middleware, microcode, or a combination thereof. When implemented in software, firmware, middleware, or microcode, the program code or code segments to perform the necessary tasks may be stored in a machine-readable medium such as a storage medium or other storages. One or more processors may perform the necessary tasks in series, distributed, concurrently, or in parallel. A code segment may represent a procedure, function, subprogram, program, routine, subroutine, module, software package, class, or a combination of instructions, data structures, or program statements. A code segment may be coupled to another code segment or a hardware circuit by passing and/or receiving information, data, arguments, parameters, or memory contents. Information, arguments, parameters, data, etc., may be passed, forwarded, or transmitted through suitable means, including memory sharing, message passing, token passing, network transmission, etc., and are also referred to as an interface, where the interface is the point of interaction with software, computer hardware, or peripheral devices.

Maintaining an asset such as a hotel or a series of hotels may be taxing. There may be changes in demand, changes to the physical structure, and changes due to outside events. The amount of data and information on the assets may quickly become overwhelming. Additionally, some data may have been reported previously. Finally, some data, like financial data, may be especially important and require immediate attention. However, if this data is not conveyed in a timely and easy-to-understand manner, it may not be acted upon.

The system and method may use artificial intelligence to analyze data and push key information to authorities who have the ability to act on the summarized data. In one aspect, data may be gathered about elements in a plurality of physical facilities, stored in memory, and a baseline established for each element. The data related to each element of the physical facilities may then be analyzed. The system and method may determine if the data for any element exceeds a threshold compared to its baseline. If the data for an element exceeds the threshold, it may be added to a display, and the communication of the display may be initiated to desired users.

In a second aspect, a method of tracking communications regarding elements of an asset may be disclosed. The system and method may receive a communication regarding an element of an asset, add it to a database, and analyze it to determine the elements involved. The system and method may determine if there are issues with the elements in the communication, add the elements to a database, and if an element requires service, format the details into a protocol and communicate them to a service provider according to an API. The element details may be added to a database, periodically collected into a report, and communicated to an authority.

In a third aspect, a computerized method of tracking the conditions of physical assets may be disclosed. The system and method may establish a baseline condition for elements of the physical assets and receive updated condition indications after a period of time. The system and method may determine if the updated conditions are materially different from the baseline. If the updated condition of an element is determined to be materially different, it may be added to a report. Conversely, if the updated condition is not materially different, it may not be added to the report. The report may then be displayed to a supervisor.

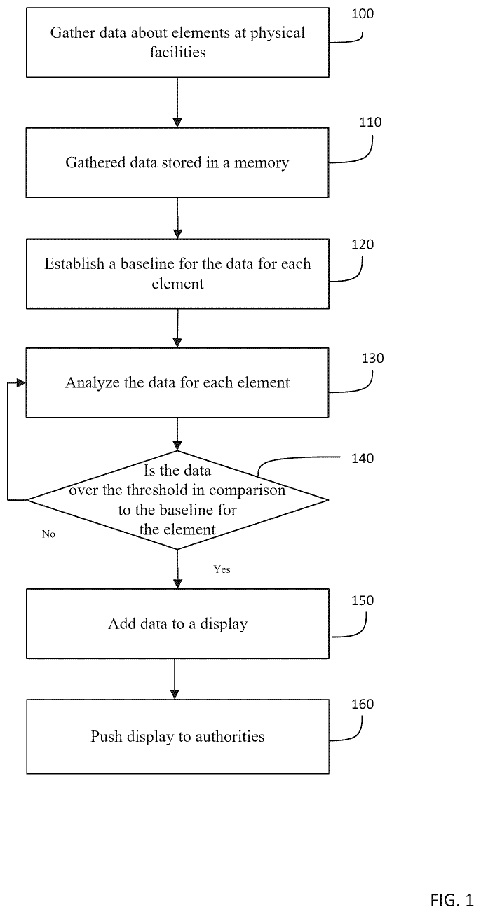

A system and method of determining and communicating data about physical facilities may be disclosed. Referring to FIG. 1, at block 100, data may be gathered about elements in a plurality of physical facilities. The physical facility may take on various forms, such as a manufacturing plant, hotel, motel, service business, or a plurality of all physical businesses. The purpose of gathering the data may be to evaluate the physical or fiscal characteristics of one or more physical facilities. Physical facilities may have elements that make up the physical facilities. For example, a hotel may have entrance doors, a front desk, elevators, a swimming pool, a sundry shop, etc. The data related to the physical facilities may be gathered in various ways.

In some embodiments, data about the physical facilities may be communicated from the various assets according to a predetermined protocol and via an application programming interface to a central location. For example, a thermostat may provide a reading on a motor. In another embodiment, the amount of sales from a sundry shop may be provided. The data about the physical facilities may be communicated periodically, such as every morning.

In other embodiments, all assets use a centralized accounting or asset management system, and the data may be pulled from this system. The data may be pulled periodically, or a system command may be executed to collect the data from the centralized system.

At block 110, the gathered data may be stored in memory so that it may be analyzed. The data may be analyzed for information on the present situation at the physical facility, or it may be stored to allow for past data analysis. The data may be stored in a database or in a file format that improves accessibility and ease of analysis.

The data may represent the status of one or more elements in the physical facility. For example, if the physical facility is a hotel, the elements may include occupancy percentage, average daily rate, total room revenue, and total revenue for all the physical facilities. The data may also include the facility name, number of keys, room revenue, total revenue, adjusted daily rate for rooms, occupancy percentage, and revenue per available room at the facility.

The data may also represent the physical status of elements such as elevators, workout equipment, electrical systems, air conditioning, heating systems, water heating, ice machines, electronic locks, Wi-Fi equipment, cooking equipment, computer equipment, refrigeration equipment, television broadcast equipment, coffee machines, gas systems, water systems, drainage systems, or roof conditions.

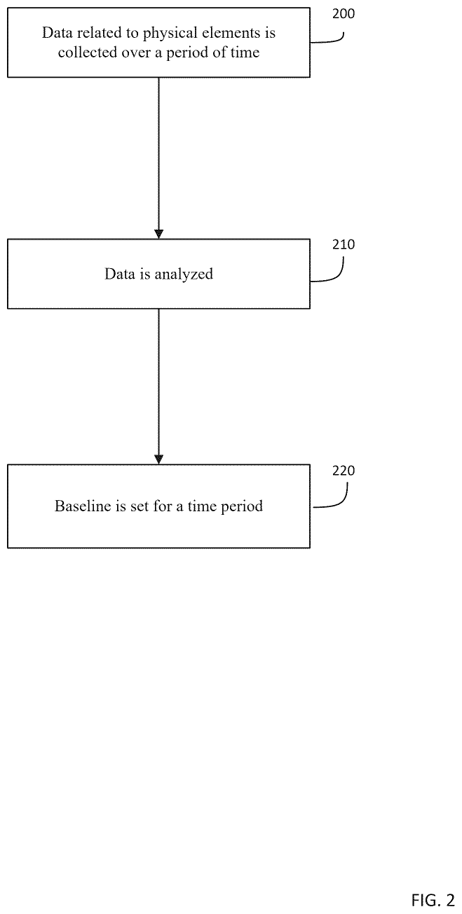

At block 120, a baseline may be established for the data for each of the elements. The baseline may be used to understand changes over time and predict failures or maintenance requirements. The baseline may be determined in various ways over a range of time periods. FIG. 2 may illustrate one method of determining a baseline.

At block 200, data may be collected over a significant period of time. The time period may be variable. In some embodiments, the time period is long enough to recognize government holidays and similar events. In additional embodiments, the time period may be extended to account for local events such as the Olympics, political conventions, weather phenomena, etc. In other embodiments, the time period may be shorter, with more frequent readings. For example, electricity usage may be tracked every fifteen minutes, while revenue may be checked once a day.

Additionally, the data on the physical asset may be in various forms. In some embodiments, the data may be in the form of digital photographs that may be analyzed. For example, a digital photograph of a parking lot may be used to ensure that all the lights in the parking lot are working at night. In other embodiments, the data may be expressed in monetary terms, such as sales from a sundry shop. In yet other embodiments, the data may be a reading from an elevator that indicates the number of cycles the elevator has completed during a given period, such as a day. At a high level, the data may relate to different aspects of a physical asset.

At block 210, artificial intelligence may be utilized on an analysis system to analyze the data over time to determine patterns. The artificial intelligence may be used to identify patterns in the elements or financial reports and attempt to identify patterns and opportunities before they become problems or to predict problems or opportunities and take steps to capitalize on opportunities or address problems before they occur. In some embodiments, the data may be images and in other embodiments, the data maybe dollar and in other embodiments, the data may be readings from equipment.

### Machine Learning

Machine learning may be used to recognize patterns and make predictions based on those patterns. By training a model on existing datasets, it may predict whether a claim matches a known resolution pattern and determine future actions based on past pattern recognition. The model may also identify deviations from established patterns, which may help in deciding future actions. The machine learning model may be trained on a model on an existing dataset and using the model to predict whether the claim matches a known pattern of claim resolution. The machine learning model may be used to predict future actions based on past pattern recognition. The machine learning model may also be used to determine pattern deviation. Logically, pattern deviation may be used to determine future actions.

A framework for machine learning algorithm like a large language model may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., maydidate programs) are evaluated, including but not limited to as accuracy, prediction and recall, squared error, likelihood, posterior probability, cost, margin, entropy k-L divergence, and/or others. Optimization components refer to computing units that perform steps that generate maydidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals clearer, given the nearly infinite number of variables that may possible be optimized in the machine learning system. Meanwhile, one or more of data integration, selection, cleaning, and/or pre-processing steps may sometimes be the most time consuming because the old adage, “garbage in, garbage out,” also reigns true in machine learning systems.

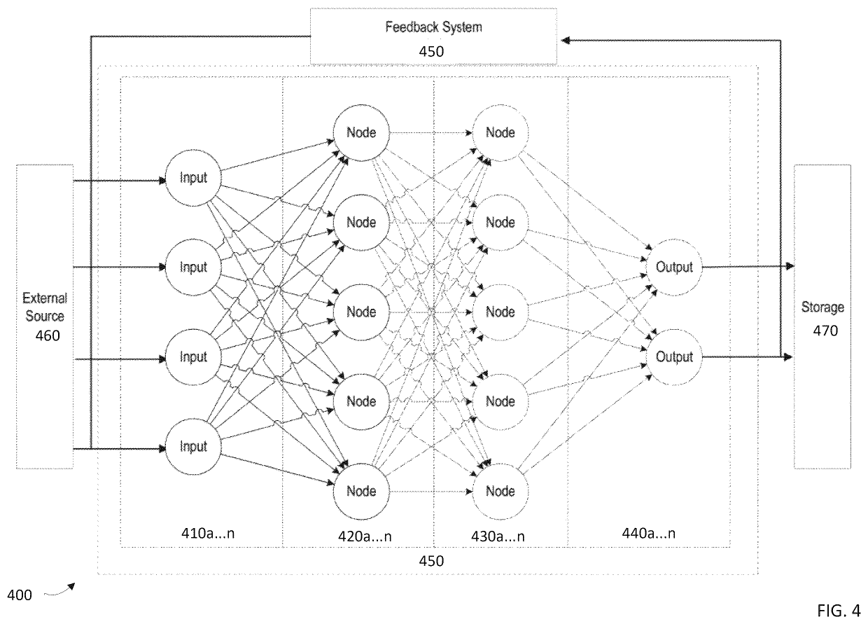

By way of example, FIG. 4 illustrates a simplified example of an artificial neural network 100 on which a machine learning algorithm may be executed. FIG. 4 is merely an example of nonlinear processing using an artificial neural network; other forms of nonlinear processing may be used to implement a machine learning algorithm in accordance with features described herein.

In FIG. 1, each of input nodes 410a-n is connected to a first set of processing nodes 420 a-n. Each of the first set of processing nodes 420a-n is connected to each of a second set of processing nodes 430a-n. Each of the second set of processing nodes 430a-n is connected to each of output nodes 440a-n. Though only two sets of processing nodes are shown, any number of processing nodes may be implemented. Similarly, though only four input nodes, five processing nodes, and two output nodes per set are shown in FIG. 4, any number of nodes may be implemented per set. Data flows in FIG. 4 are depicted from left to right: data may be input into an input node, may flow through one or more processing nodes, and may be output by an output node. Input into the input nodes 410a-n may originate from an external source 460. Output may be sent to a feedback system 450 and/or to storage 470. The feedback system 450 may send output to the input nodes 410a-n for successive processing iterations with the same or different input data.

In one illustrative method using feedback system 450, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network, the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combinations of techniques, to update weights in each layer. When appropriate, the neural network may include mechanisms to prevent overfitting—such as regularization (L1 or L2), dropout, and/or other techniques. The neural network may also increase the amount of training data used to prevent overfitting.

Once data for machine learning has been created, an optimization process may be used to refine the machine learning model. The optimization process may include (1) training the model to predict an outcome, (2) defining a loss function that serves as an accurate measure to evaluate the model's performance, (3) minimizing the loss function through methods like gradient descent or other algorithms, and/or (4) optimizing a sampling method, such as using a stochastic gradient descent (SGD) method where, instead of feeding an entire dataset to the algorithm for each step, a subset of data is sampled sequentially. For example, optimization may involve minimizing the number of false positives to enhance user experience. Alternatively, an optimization function may aim to minimize the number of missed positives to reduce losses from exploits.

In one example, FIG. 4 depicts nodes that perform various types of processing, such as discrete computations, computer programs, and/or mathematical functions implemented by a computing device. For instance, the input nodes 410a-n may comprise logical inputs from different data sources, such as one or more data servers. The processing nodes 420a-n may consist of parallel processes executing on multiple servers in a data center. The output nodes 440 a-n may be the logical outputs that are ultimately stored in result data stores, which could be the same or different data servers as those used for the input nodes 410a-n. Notably, the nodes need not be distinct; for example, two nodes in any two sets may perform the exact same processing, and the same node may be repeated in the same or different sets.

Each of the nodes may be connected to one or more other nodes. The connections may link the output of a node to the input of another node, with each connection potentially having a weight value. For example, one connection may be weighted as more important or significant than another, thereby influencing the degree of further processing as input traverses the artificial neural network. Such connections may be modified so that the neural network may learn and/or be dynamically reconfigured. Although nodes are depicted as having connections only to successive nodes in FIG. 4, connections may be formed between any nodes. For instance, one processing node may be configured to send output to a previous processing node.

Input received at the input nodes 410a-n may be processed through the processing nodes, such as the first set of processing nodes 420a-n and the second set of processing nodes 430a-n. This processing may result in output at the output nodes 440a-n. As depicted by the connections from the first set of processing nodes 420a-n and the second set of processing nodes 430a-n, processing may involve multiple steps or sequences. For example, the first set of processing nodes 420a-n may act as a rough data filter, while the second set of processing nodes 430a-n may serve as a more detailed data filter.

The artificial neural network 400 may be configured to effectuate decision-making. As a simplified example for the purposes of explanation, the artificial neural network 400 may be configured to detect faces in photographs. The input nodes 410a-n may be provided with a digital copy of a photograph. The first set of processing nodes 420a-n may be each configured to perform specific steps to remove non-facial content, such as large contiguous sections of the color red. The second set of processing nodes 430a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 400 may then predict the location on the face. The prediction may be correct or incorrect.

The feedback system 450 may be configured to determine whether or not the artificial neural network 400 made a correct decision. Feedback may comprise an indication of a correct answer and/or an indication of an incorrect answer and/or a degree of correctness (e.g., a percentage). For example, in the facial recognition example provided above, the feedback system 450 may be configured to determine if the face was correctly identified and, if so, what percentage of the face was correctly identified. The feedback system 450 may already know a correct answer, such that the feedback system may train the artificial neural network 400 by indicating whether it made a correct decision. The feedback system 450 may comprise human input, such as an administrator telling the artificial neural network 400 whether it made a correct decision. The feedback system may provide feedback (e.g., an indication of whether the previous output was correct or incorrect) to the artificial neural network 400 via input nodes 410a-n or may transmit such information to one or more nodes. The feedback system 450 may additionally or alternatively be coupled to the storage 470 such that output is stored. The feedback system may not have correct answers at all, but instead base feedback on further processing: for example, the feedback system may comprise a system programmed to identify faces, such that the feedback allows the artificial neural network 400 to compare its results to that of a manually programmed system.

The artificial neural network 400 may be dynamically modified to learn and provide better input. Based on, for example, previous input and output and feedback from the feedback system 450, the artificial neural network 400 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally, or alternatively, the node may be reconfigured to process photos differently. The modifications may be predictions and/or guesses by the artificial neural network 400, such that the artificial neural network 400 may vary its nodes and connections to test hypotheses.

The artificial neural network 400 need not have a set number of processing nodes or number of sets of processing nodes but may increase or decrease its complexity. For example, the artificial neural network 400 may determine that one or more processing nodes are unnecessary or should be repurposed, and either discard or reconfigure the processing nodes on that basis. As another example, the artificial neural network 400 may determine that further processing of all or part of the input is required and add additional processing nodes and/or sets of processing nodes on that basis.

The feedback provided by the feedback system 450 may be mere reinforcement (e.g., providing an indication that output is correct or incorrect, awarding the machine learning algorithm a number of points, or the like) or may be specific (e.g., providing the correct output). For example, the machine learning algorithm 400 may be asked to detect faces in photographs. Based on an output, the feedback system 450 may indicate a score (e.g., 75% accuracy, an indication that the guess was accurate, or the like) or a specific response (e.g., specifically identifying where the face was located).

The artificial neural network 400 may be supported or replaced by other forms of machine learning. For example, one or more of the nodes of artificial neural network 400 may implement a decision tree, associational rule set, logic programming, regression model, cluster analysis mechanisms, Bayesian network, propositional formulae, generative models, and/or other algorithms or forms of decision-making. The artificial neural network 400 may effectuate deep learning.

A large language model may be a language model characterized by its large size. Their size is enabled by AI accelerators, which are able to process vast amounts of text data, mostly scraped from the Internet. The artificial neural networks which are built may contain from tens of millions and up to billions of weights and are (pre-)trained using self-supervised learning and semi-supervised learning. Transformer architecture contributed to faster training.

As language models, they work by taking an input text and repeatedly predicting the next token or word. Up to 2020, fine tuning was the only way a model could be adapted to be able to accomplish specific tasks. Larger sized models, such as GPT-3, however, may be prompt-engineered to achieve similar results. They are thought to acquire embodied knowledge about syntax, semantics and “ontology” inherent in human language corpora large language models are trained using self-supervised learning or semi-supervised learning. This means that they are trained on large amounts of unlabeled text. Large language models may adjust their internal parameters and learn from new inputs from users over time.

Large language models are trained to predict the next word in a sentence based on the previous input sentence. This is a self-supervised learning task because you are not defining separate output labels. The process is repeated until the model reaches an acceptable level of accuracy. Some large language models, like InstructGPT and ChatGPT, use both supervised learning and reinforcement learning. The combination of the two is crucial for optimal performance.

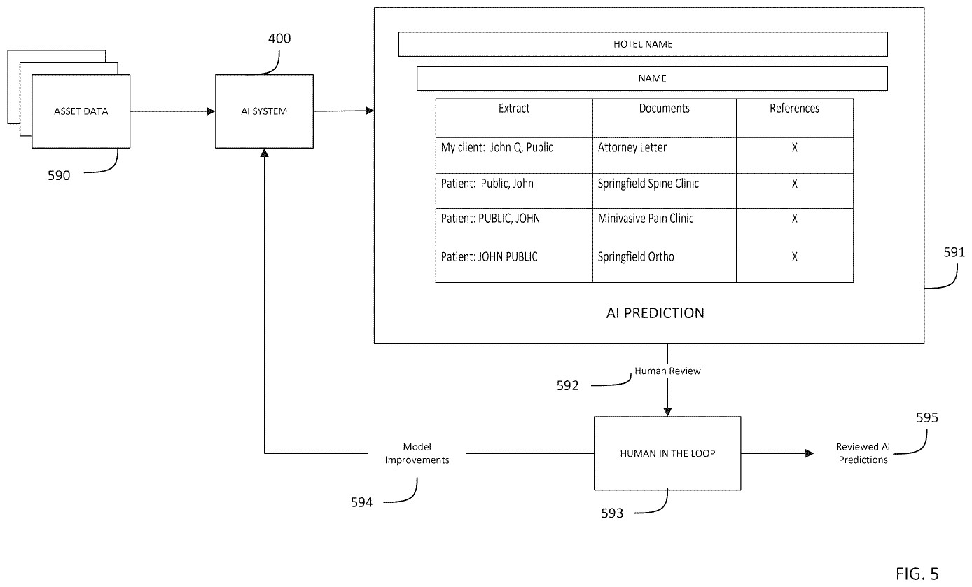

Referring to FIG. 5, humans also may assist the AI system 400. Data about the assets 590 may be communicated to the AI system 400 where the AI system may extract and break down the data into understandable parts 591 in an AI module 591. The AI module 591 may then make predictions based on the data. A human 592 may review the predictions to ensure the predictions make logical sense. The human may make recommendations 593 to the predictions. The human modifications may be used to improve the AI model 594 and the reviewed AI predictions 595 may be used by the system and method.

Referring again to FIG. 2, at block 220, a baseline may be set for a time period based on the analysis from the artificial intelligence system. The baseline may be as specific as desired and may depend on the physical assets. For example, a hotel is typically reserved one night at a time, so the baseline may reflect daily demand. Other situations, such as elevator use, may be based on the hour of the day, as the elevator may be heavily used in the morning and after dinner. In additional scenarios, the baseline may be related to events such as a baseball World Series being in town, a convention, a festival, or similar occurrences.

The baseline may also be determined for a region. For instance, the Indy 500 may bring a significant amount of traffic to Indianapolis at the end of May, while the Boston Marathon may attract a large number of people to Boston. The system and method may account for the need to adjust the baseline based on regional events. Logically, the baseline may pertain to a single asset in a region or to multiple assets within a region.

The definition of a region may also depend on the current facts and circumstances. A large event, such as a Super Bowl football game, may occupy virtually all the hotel rooms in a city, while a smaller event, such as a concert, may affect only the hotel rooms near the venue. The region may be defined over time, and artificial intelligence may assist in defining useful regions. For example, the east side of a city may experience increased rentals during an event, while areas to the west may not see a similar increase, even though the event is in town.

The baseline may also apply to groups. For example, artificial intelligence may determine that luxury hotels across a city experience increased traffic during certain events, while lower-end hotels may see less traffic. Similarly, hotels housing athletes may have more people using the stairs, which could mean less use of elevators but increased use of swimming pools. Artificial intelligence may group assets into similar classes to provide insights into usage patterns and predict potential issues.

Referring again to FIG. 1, at block 130, the data for each element related to one of the physical facilities may be analyzed. The analysis may aim to determine the condition or status of the elements in the physical facilities for various reasons, such as identifying potential problems, theft, or other issues. It may also analyze various financial measures for a physical facility. For example, the system and method may review the occupancy percentage for all physical facilities, the average daily rate, total room revenue, and total revenue. Elements may include physical components, service elements, financial metrics, or other aspects related to a physical entity.

At block 140, the system and method may determine if the data for each element exceeds a threshold compared to the baseline for each of the elements in the physical facility. The threshold may be preset, determined over time using an algorithm or artificial intelligence, or established by an authority. For example, the authority may always want to know the occupancy percentage of a property.

The threshold for each of the elements may be created by a threshold determination unit. The threshold determination unit may determine when the elements have changed to a point where the change is determined to be significant enough that it should be reported to management.

The threshold determination unit may also take into account the baseline patterns discovered in block 130, as variations may be more pronounced during certain periods or times of day. The threshold determination unit may review the baseline for the relevant time period and determine whether the current score or reading for a unit during that time period is significantly different from the expected reading or score. The time period may depend on the asset or measurement in question.

The threshold may be determined in a variety of ways. In one embodiment, the threshold determination unit may calculate the standard deviation for each of the elements and report issues that fall outside a single standard deviation for the element. In other embodiments, the threshold may be set by an authority. Alternatively, artificial intelligence may be used to analyze past data from elements and determine the appropriate thresholds for each element.

To establish appropriate data reporting thresholds, a structured approach encompassing various methods and considerations may be employed:
Data Sensitivity Levels: The process begins by categorizing data according to its sensitivity. This classification might include levels such as public, confidential, restricted, or classified. Based on these categories, reporting thresholds are defined, with stricter thresholds applied to more sensitive data.
Regulatory Requirements: Compliance with legal and regulatory frameworks may be a factor. The system may assess whether data reporting is required by regulations. Reporting thresholds are then set to align with these legal requirements and industry standards.
Risk Assessment: The next step may involve evaluating the risks associated with potential data breaches or misuse. Reporting thresholds may be adjusted based on these assessed risk levels, with lower thresholds established for higher risk scenarios.
Impact Analysis: Analyzing the potential impact of unreported data on stakeholders may matter. The analysis may include evaluating potential financial loss or reputational damage. Thresholds may be determined based on the level of potential impact, prioritizing scenarios with higher consequences.
Anomaly Detection: The system may define normal data patterns and behaviors. Reporting thresholds may then be set to flag any anomalies or deviations from these patterns. Data may be reported if such deviations exceed predefined thresholds.
Historical Data Analysis: Reviewing past incidents and analyzing historical data may help in identifying patterns relevant to reporting. Insights gained from these past incidents may be used to refine and adjust reporting thresholds.
Stakeholder Input: Gathering input from relevant stakeholders, such as data owners and subject matter experts, may help. Reporting thresholds may be defined based on collective feedback and expectations.
Automated Monitoring Systems: Deploying automated tools to monitor data may enhance efficiency. These tools flag potential reporting triggers, and thresholds may be set within these systems to enable automatic data reporting.
Data Integrity Checks: Ensuring data accuracy and integrity before reporting may also occur. Thresholds may be set to address data integrity issues or discrepancies, ensuring that only reliable data is reported.
Ethical Considerations: Evaluating the ethical implications of data reporting may involve considering privacy concerns and potential harm. Reporting thresholds may be established to align with ethical standards and practices.
Decision-Making Frameworks: Developing criteria and frameworks for decision-making may support setting appropriate reporting thresholds. These frameworks may be applied to determine the most suitable thresholds.
Benchmarking: Finally, comparing against industry standards may help in adopting best practices for similar data reporting scenarios. Benchmarking may ensure that reporting thresholds align with industry norms and practices.

Each of these methods may be tailored to specific contexts and requirements, and combining multiple approaches may provide a comprehensive strategy for setting effective reporting thresholds.

In another aspect, items that are significantly over the threshold may be displayed in one color, while items that are closer to the threshold may be displayed in a different color. Using different colors may help users easily identify elements that are significantly over the threshold. Similarly, items requiring less attention may be shown in a more subdued color.

### Statistics for Baseline

Using statistics to determine a threshold over a baseline may involve several steps to ensure that the threshold is both meaningful and effective. Several possible embodiments are described below.

To establish a baseline for analysis, baseline data may be collected by defining what constitutes normal operating conditions or expected values for the parameter of interest. Historical data may be gathered that represents typical behavior, with an adequate sample size to ensure reliability.

Once the baseline data is collected, it may be analyzed. Descriptive statistics such as the mean, median, standard deviation, and range may be calculated to understand the data's central tendency and variability. The distribution of the data may then be assessed to determine whether it follows a normal distribution or exhibits skewness.

With the baseline data analyzed, thresholds may be set using statistical methods. One approach is the Standard Deviation Method, where thresholds may be determined based on deviations from the mean. For example, if the mean is μ and the standard deviation is σ, a threshold may be set at μ+kσ, where k is a factor (such as 2 or 3) that accounts for variability.

Another method is the Percentile Method, which may set thresholds based on the distribution of the baseline data. For instance, a threshold at the 95th percentile may capture values higher than 95% of the baseline observations.

Control Limits may also be used, applying control chart methods to set upper and lower limits based on the baseline data. For a normal distribution, this may involve setting limits at μ±3σ, covering the majority of the data.

It may be useful to consider outliers and variability in the data. Outliers may be identified and managed appropriately, and thresholds may be adjusted to account for variability to avoid false alarms.

Dynamic thresholds may be implemented if applicable, adjusting over time based on updated baseline data. This may involve using a rolling window approach to continuously refresh the baseline and thresholds based on recent data.

After setting the thresholds, the thresholds may be validated. Testing may be performed with historical data to assess how well the thresholds identify significant deviations, and simulations or sensitivity analyses may be conducted to evaluate their performance under various conditions.

Finally, the thresholds may be deployed in the monitoring system, with continuous monitoring of their performance and adjustments made as necessary based on new data and evolving conditions.

For example, if baseline data shows a mean (μ) of 100 and a standard deviation (σ) of 10, thresholds may be set using different methods:
Standard Deviation Method: A threshold at μ+2σ=100+2×10=120.
Percentile Method: For normally distributed data, the 95th percentile is approximately μ+1.645σ≈100+1.645×10≈116.45.
Control Limits: Limits set at μ±3σ=100±30, resulting in 70 and 130.

Each method provides a different perspective on threshold setting, and the choice of method depends on the specific application and requirements.

At block 150, in response to the data for an element being determined to be over a threshold, the data for that element may be added to a display. The purpose of the display may be to keep an authority informed about key data elements or data that deviates from expectations. The display may be organized in various ways. In some embodiments, an authority may designate elements of interest, and scores or statuses for those elements may be included in the display. In other embodiments, the display may focus on data for elements that are over the threshold. Alternatively, an authority may establish criteria for which data related to elements should be displayed.

At block 160, the system and method may initiate the communication of the display to the desired users. The purpose of the display is to keep authorities informed about key data with minimal effort required on their part. The report of the data on elements determined in block 150 may be sent to authorities on a periodic basis, ensuring they are informed of key issues or data. For example, the report may be automatically communicated to authorities every morning.

Authorities may include a variety of individuals in different roles. In some cases, the authority may be the owners of the asset. In other cases, the authority may be the individuals responsible for managing the asset, such as hotel managers or booking agents. In yet other instances, the authority may be maintenance personnel, with the data relating to assets that require maintenance. Additionally, the authority could be a front desk manager, and the data might pertain to issues currently present in a hotel or business, allowing a later authority to quickly assess the asset's status through a review of the report.

The authority may also include maintenance personnel, such as a maintenance supervisor or vendors tasked with maintaining and repairing equipment related to the assets. Elements of the asset that may require maintenance include:
Elevators
Workout equipment
Electrical issues
Air conditioning
Heating systems
Water heating
Ice machines
Electronic locks
Wi-Fi equipment
Cooking equipment
Computer equipment
Refrigeration equipment
Television broadcast equipment
Coffee machines
Gas issues
Water issues
Drainage issues
Roof issues

The data in the report may be formatted in various ways. In some embodiments, the data may be presented in a simple format that is easily readable, with key pieces of data clearly highlighted. In other embodiments, key pieces of data may be hyperlinks that provide access to more detailed information underlying the key data on the element. Selecting the hyperlink may display the underlying data in an additional view, which could be located below, beside, or overlaying the key data.

Additionally, the key data may be valuable for maintenance personnel. For example, if the key data indicates that an elevator is not functioning, the data about the elevator element may be formatted according to a protocol and communicated to a service provider for the element. The key data may be sent to an application at the service provider, which may use an application programming interface (API) to interpret the data. The service provider may then understand the problem, locate the necessary parts and tools, and arrange for the repair of the malfunctioning element.

Protocols may be generic for all service providers or specific to each service provider, as different providers may need different information. Protocols and related APIs may be tailored to each service provider, each service, or each product manufacturer. For example, an elevator service provider may need to know the type of elevator and any error codes. Similarly, a swimming pool service provider might require additional data such as water temperature, pH level, chlorine level, hardness level, water level, flow rate of the filter pump, filter manufacturer, pump manufacturer, and the date of the last pool service.

In some embodiments, the service personnel may have a digital twin of the asset, allowing them to determine the likely cause of the problem by reviewing the data. The digital model may contain information on the components of the asset, facilitating the identification of problem parts or systems and leading to a faster determination of the required parts and tools. Additionally, in some embodiments, the proposed fix for the problem element may be tested virtually to assess its effectiveness before implementation.

In another aspect, a follow-up task may be added to a daily problem list for the asset. For example, if the elevator requires service, the system and method may include the elevator issue on the daily problem list until it is resolved. This ensures that the authorities on the distribution list are aware that the issue still exists and needs to be addressed.

Additionally, a problem correction list may be maintained by the system. For instance, if an elevator stops working and the control panel is found to be unresponsive, the solution might involve replacing the control panel. The problem correction list would be updated to reflect that the elevator error was corrected by replacing the control panel. In the future, the authority may review past occurrences of the same error and the solution that resolved it. Moreover, the problem correction list may be shared with other assets in the system or with the manufacturer, enabling the manufacturer to recognize recurring problems and have proven solutions readily available.

The problem solution report may also include the cost to fix the element. By collecting pricing information, the authority may ensure that the costs for repairs are fair and reasonable. For example, if a new panel costs $2,500 in Rockford, Illinois, the price for similar parts should be somewhat comparable in New York City, although service costs may vary due to local labor rates. At a minimum, the solution report should provide insight into the costs of fixing similar items in different markets and offer an understanding of labor costs across various regions. Aggregating reports on many assets, especially similar ones, may create a comprehensive master report of problems, solutions, and related costs.

Artificial intelligence may also be used to analyze the data. It may review the master report of problems and solutions to determine maintenance procedures and schedules aimed at reducing future issues. The report may be communicated to the authority periodically.

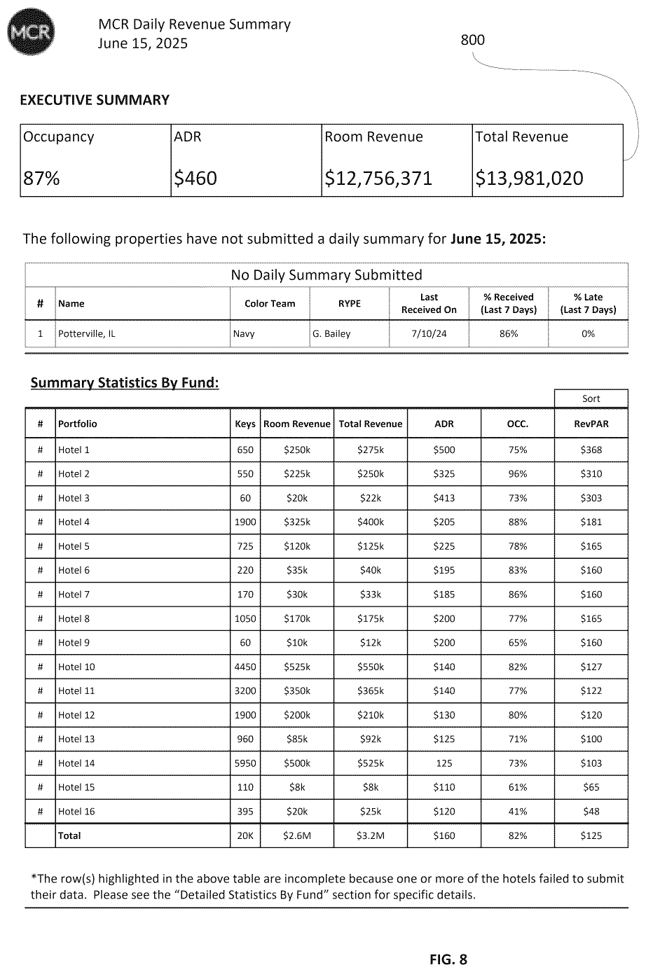

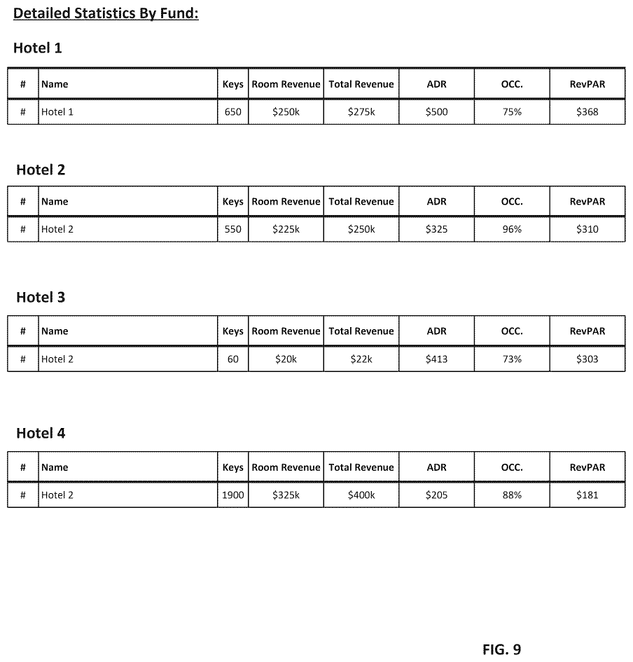

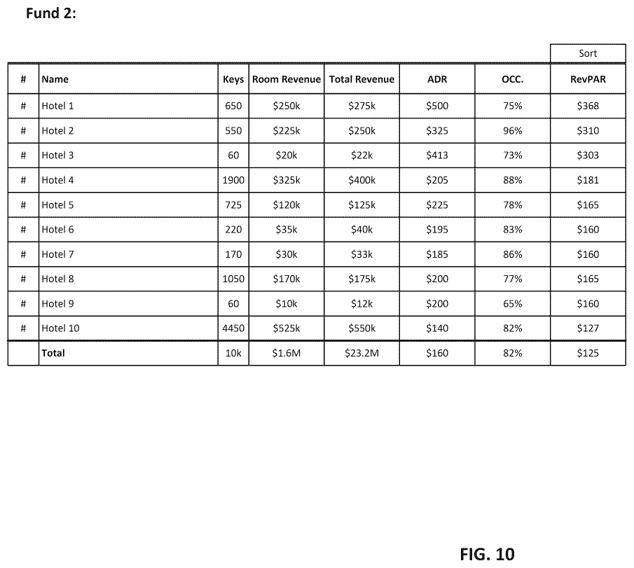

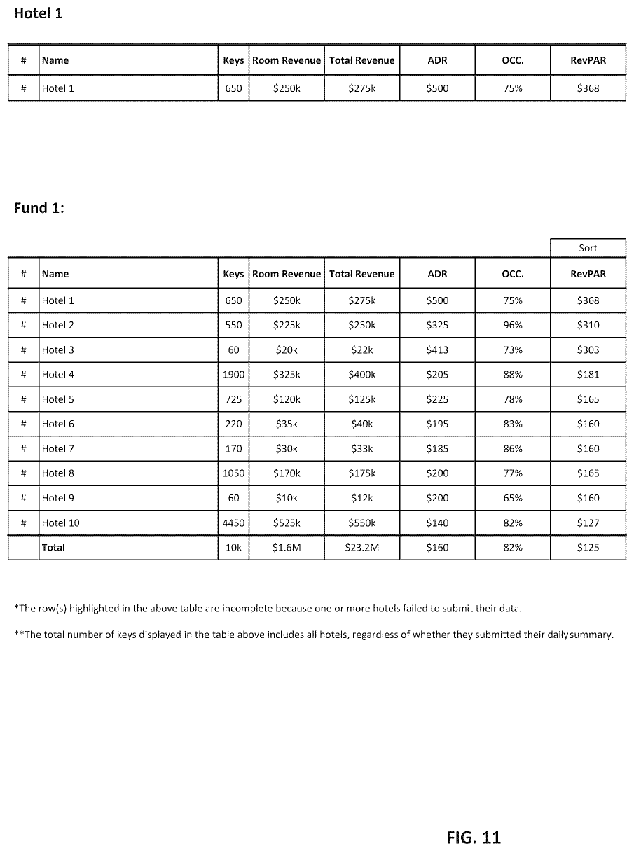

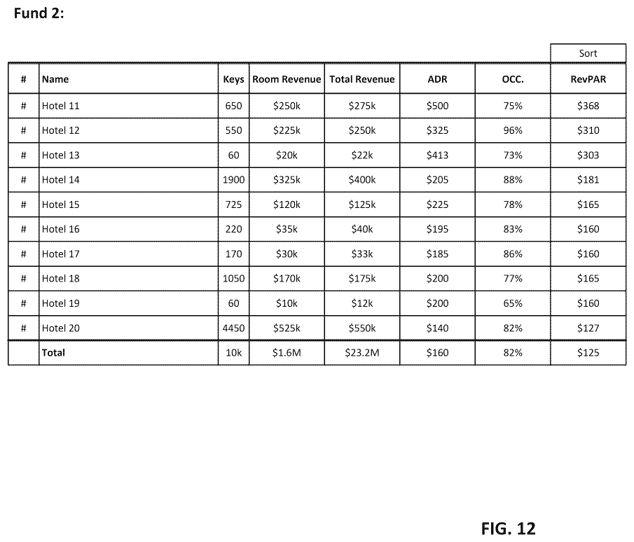

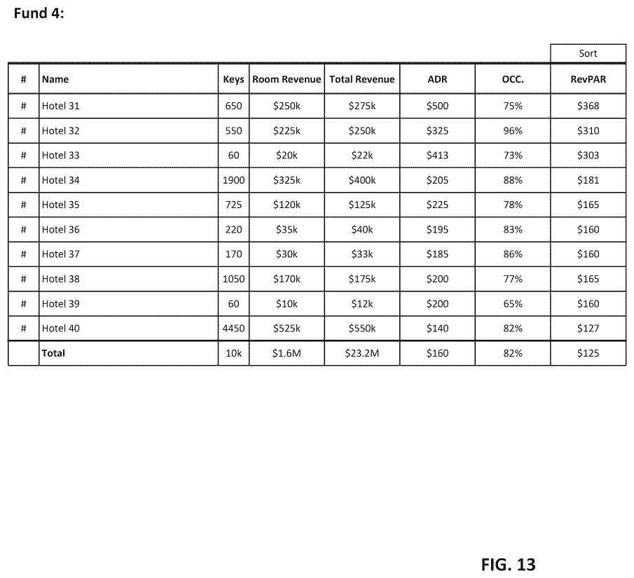

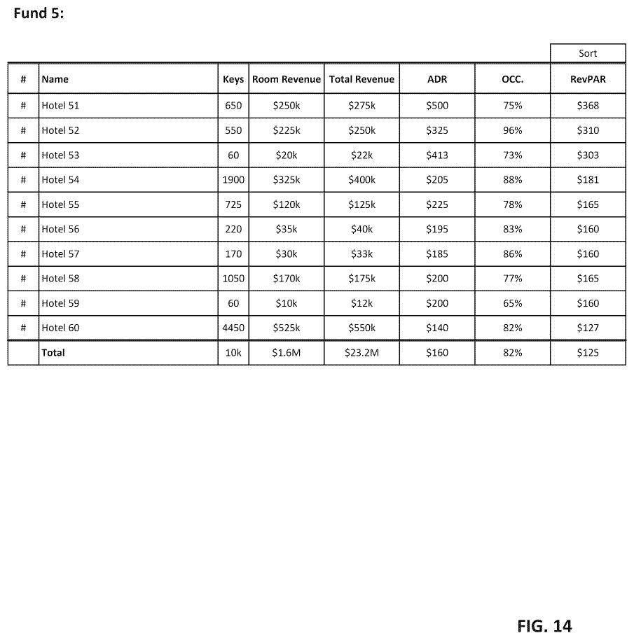

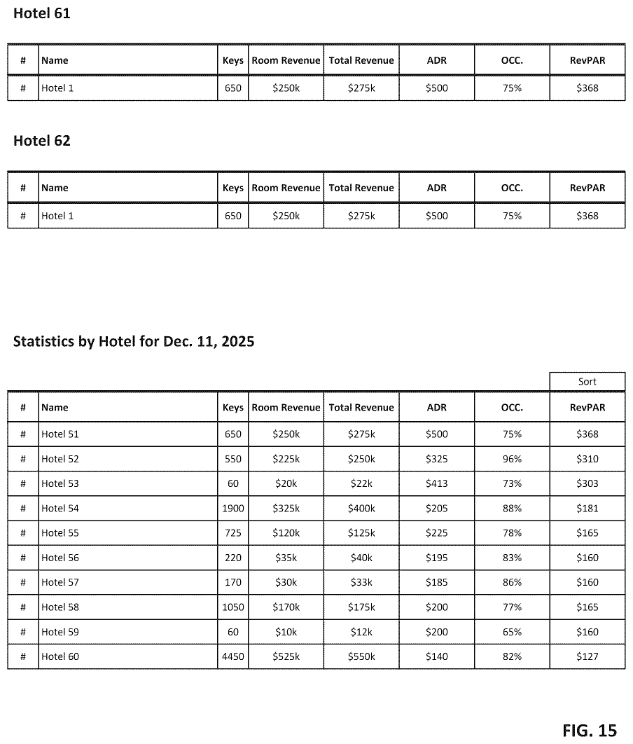

A sample report may be illustrated in FIGS. 8-16. Again, this is just one embodiment, and many embodiments are contemplated based on the desires of the user, the data itself and the audience. In FIG. 8, an executive summary has blue boxes 800 with key data. In this example, the system and method has determined that occupancy, average daily revenue (ADR), room revenue and total revenue are the key metrics which may be pushed automatically to authorities. If data from a property is missing, it may be noted. If the assets are broken down by different ownership groups, the report may present a summary of the assets in the ownership group along with come key statistics. In the hotel example, the key statistics may include the number of keys at the hotel, the room revenue, the total revenue, the average daily rate, the occupancy percentage and the revenue per available room (RevPAR) may be added to the report. Subsequent pages of the report such as in FIGS. 9-15 may add more detail about the specific assets in a group of assets, such as specific hotels owned by a group. In addition, all assets may be listed as in FIG. 15 with their relevant statistics.

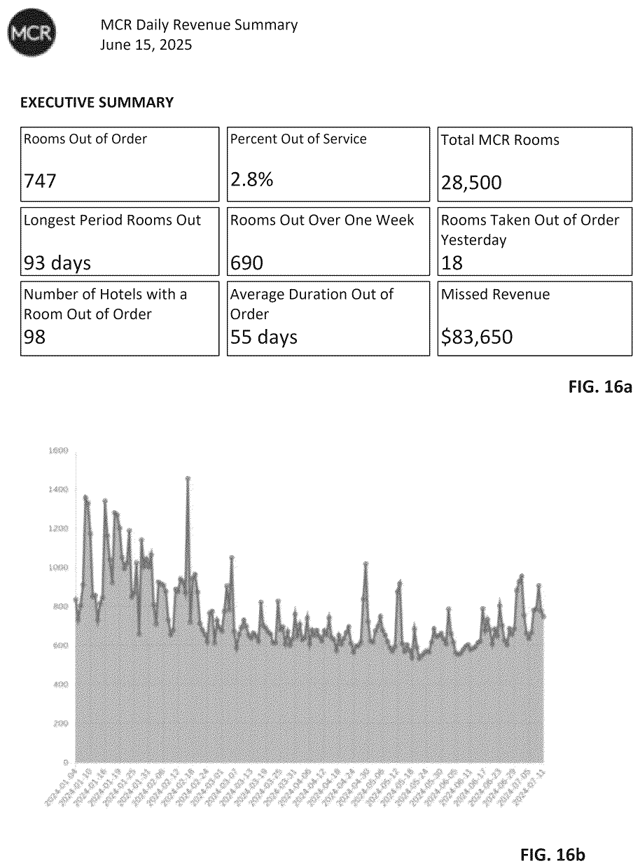

FIG. 16a may illustrate another summary report. The report may list assets that are out of order. In the hotel example, the highlighted boxes may list the number of rooms out of order, the longest period rooms out of order, the number of hotels with a room out of order, the percentage of rooms out of order, the rooms out over one week, the average duration out of order, the total rooms owned by a group, the rooms that went out of order yesterday and the missed revenue from rooms being out of service. Of course, other financial measures may be relevant and may be part of the summary report. FIG. 16b may illustrate the total rooms out of service over time such that a quick glance may provide useful information about the number of rooms out of service.

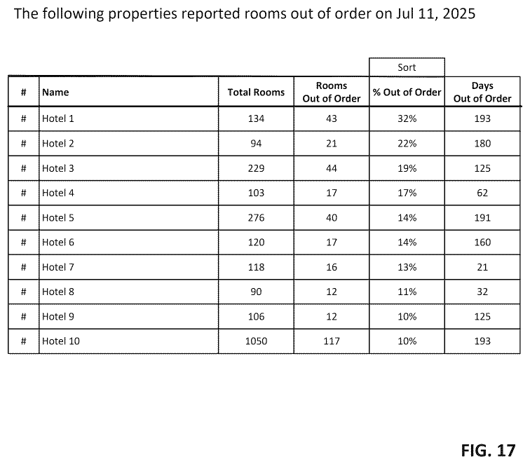

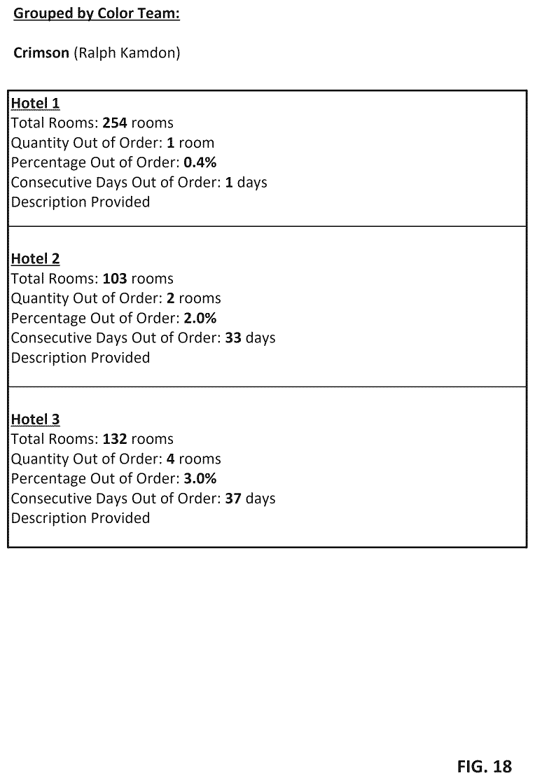

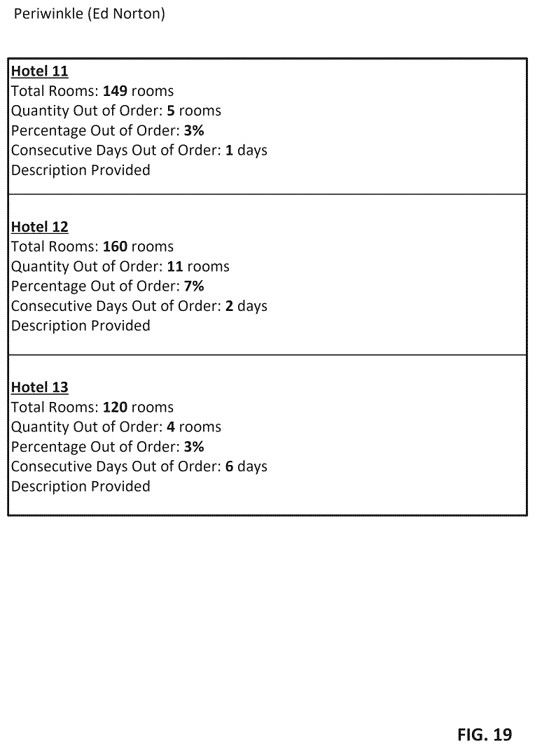

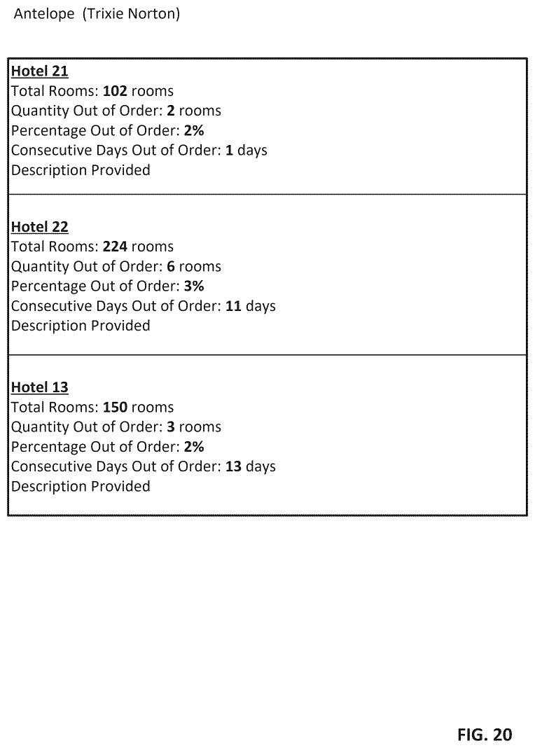

FIG. 17 may illustrate the specific locations that have assets out of order. The report may break down the assets even further. In the hotel example, the total number of rooms may be listed for each hotel along with the rooms out of order, the percentage of rooms that are out of order and the days a room has been out of order. FIGS. 18-20 may break down the assets by responsible team members along with the number of rooms, the quantity that are out of order, the percentage that are out of order, the consecutive number of days a room has been out of order and a description of the reason rooms are out of order. This report may allow an authority to ask further questions of the team member responsible for the out of service rooms.

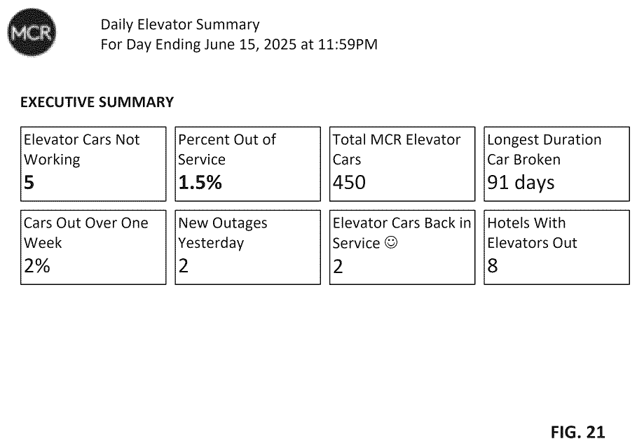

FIG. 21 may illustrate a similar report for an asset. Key machinery may be key to profitable and smooth operations. This report may highlight the downtime of key assets. In the hotel example, an elevator that is out of service may cause operations to be challenging, with lots of complaints. The high-level report may have an executive summary that highlights data that has been determined to be relevant. In this hotel example, the report may highlight the elevator cars that are not working, the cars out over one week, the percentage of cars out of service, the new elevator outages since the previous day, the total number of elevator cars, the elevator cars that are back in service, the longest duration a car has been broken and the number of hotels with an elevator out.

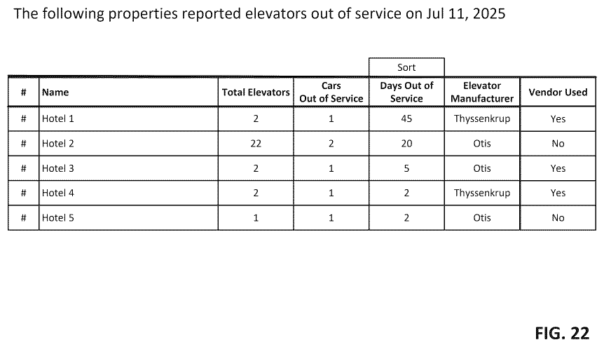

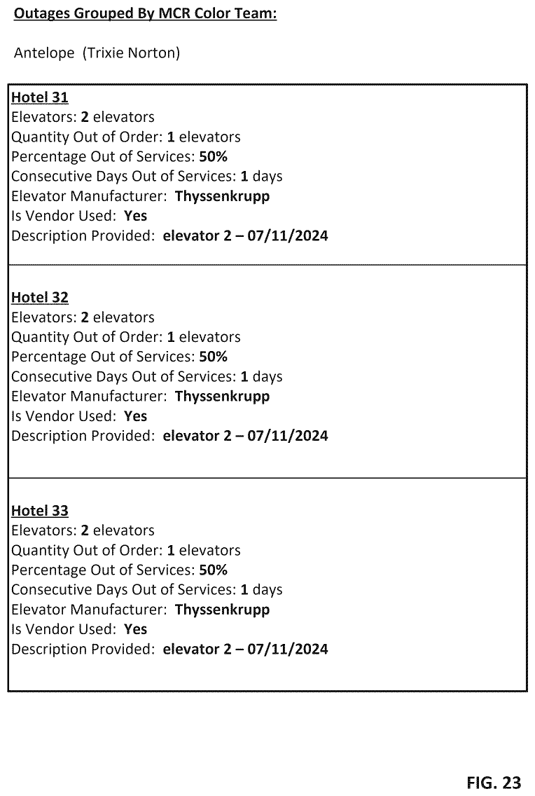

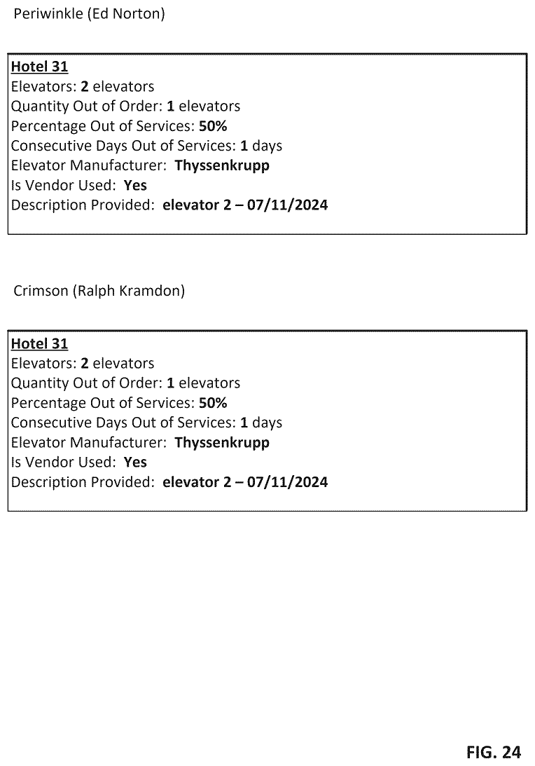

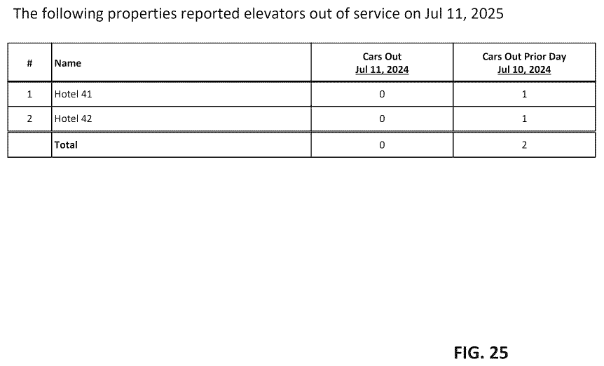

FIGS. 22-25 list additional detail about the assets with issues. In the hotel example, the specific hotels may be listed along with the total number of elevators, the number elevator cars that are out of service, the days out of service, the elevator manufacturer and whether a maintenance firm is used for the elevator. FIGS. 23-25 break the broken elevators down by team member. FIG. 25 lists the assets that have elevators that are back in service.

### Phone Report

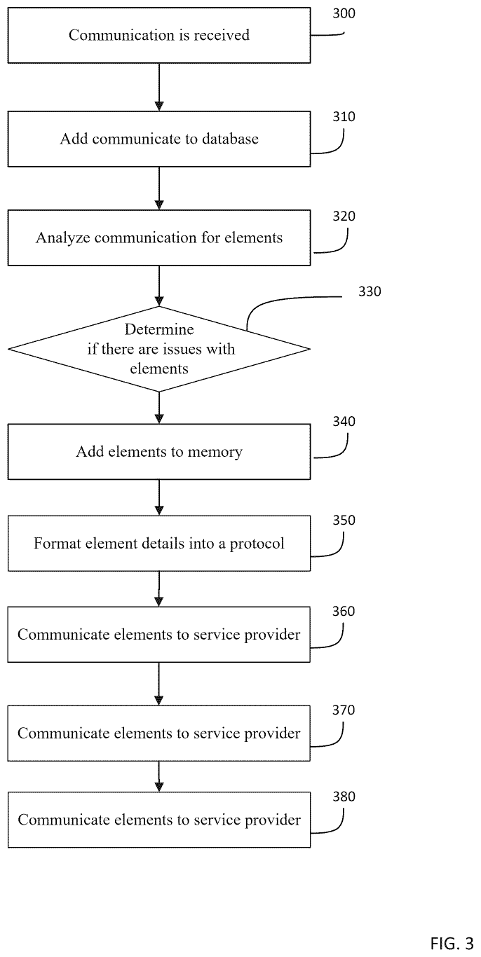

Referring to FIG. 3, another aspect of the invention may be disclosed. In many assets, such as hotels, issues may be directed to a central authority like the front desk or a communication answering service. Some issues are straightforward, such as sending more pillows to room 223. Others, like a pool being green, are more complex and may require days and multiple service personnel to address. Tracking these issues is useful for several reasons, including informing future employees about ongoing issues, addressing problems before they become expensive or embarrassing, and improving maintenance schedules based on feedback to the central authority.

At block 300, a communication regarding an element of an asset may be received. The communication may take various forms, such as a phone call, email, text, in-person conversation, or handwritten note. Other forms of communication are also possible and contemplated.

The communication may serve multiple purposes. It could be a request for repair, a compliment, or an inquiry about operating hours, directions, or recommendations for places to eat. Other purposes of communication are also possible.

The element of the asset may be as described previously. It could be a physical component like an elevator control panel or a revenue line such as snack sales at a hotel front desk.

At block 310, the communication may be added to a database. This helps track the communication to ensure it is addressed, monitor communications over time to identify and resolve recurring issues, and share data across a large group of assets to determine patterns, such as using artificial intelligence to identify issues needing attention, including preventive and predictive maintenance.

At block 320, the communications may be analyzed to identify the elements of the asset involved. The analysis aims to determine which specific elements may have issues and need further review. As previously discussed, assets consist of various elements. For example, an elevator may include a hydraulic system, electrical system, and communication system, each with its components. Similarly, an elevator may be part of a hotel's assets, and the hotel may be part of a larger group of hotels.

At block 330, the system and method may assess whether there are issues with the elements mentioned in the communication. The goal is to understand if there is a problem that needs addressing and how critical it may be. For example, an elevator might report its number of cycles, indicating future maintenance needs as it approaches a threshold. Alternatively, a financial figure like the average room rate may be below expectations or baseline, suggesting the need for adjustments in the pricing algorithm. The average room rate is an element of the hotel's financial performance, which is an asset.

At block 340, the system and method may add the element details to a database. The database helps organize, query, and access data on the elements for further review. Over time, the data may be analyzed by an engine using artificial intelligence to identify patterns and make predictions. The database also facilitates comparisons among similar elements of assets.

At block 350, if the system determines that an element requires service, the element details may be formatted into a protocol. Protocols are standardized formats for data. For example, a protocol might include fields for the element name, manufacturer, serial number, and error code. Using a protocol ensures quick, secure, and consistent retrieval of desired information.

At block 360, the element details may be communicated to a service provider via an application programming interface (API). The API ensures consistent and efficient data communication, knowing that specific fields will contain certain types of information, thus avoiding the need to analyze the data to locate specific details like the manufacturer.

At block 370, the element details may be added to a database. This allows for easy access, querying, and sorting of the details. Additionally, it helps track the element details over time to identify and address issues. Sharing data across a large group of assets may reveal patterns, such as those identified through artificial intelligence for preventive and predictive maintenance, and help spot elements significantly deviating from baselines.

At block 380, the system and method may periodically collect the element details into a report. The purpose of the report is to ensure that relevant personnel are informed and may track information about elements that have been reported or have issues. The report may be automatically created and communicated on a regular basis, ensuring that relevant individuals are consistently updated about the status of issues and that no issues are forgotten or overlooked. In some embodiments, a follow-up task may be included for the element to remind readers to address the issues.

In some embodiments, the frequency with which issues occur may be included in the report. For example, if an ice maker in a hotel breaks down every other day, it may be useful for an authority to know this pattern. Conversely, if this is the first time the ice maker has malfunctioned, that information is also valuable. Additionally, past reports related to the elements may be included. For instance, if the ice maker had previously broken down due to a clogged water filter, this historical repair information and vendor details may be part of the report. The report may also include the cost of the previous repair, which could expedite the current repair process.

Once elements are fixed, they may be removed from the current report. However, in some embodiments, the report may still list these elements with a note indicating that they have been fixed, in case there are questions about their status.

The data on the element, including the fix, cost, and vendor, may be added to a database to create a baseline for the element. This baseline data may include the time between fixes, the cost of repairs, the solutions applied, and the vendor who performed the work. The database may also track the usage of the element, such as the number of cycles or the duration of use between issues. Reports from multiple locations may be aggregated to form a master report, which includes cumulative solutions and costs for repairs.

The data on the element may be formatted according to a protocol and communicated to a service provider. Protocols are standardized formats for data. For example, a protocol might include fields for the element name, manufacturer, serial number, and error code. Using a protocol ensures that information is quickly located in a secure and consistent manner. The element details may be communicated to a service provider using an application programming interface (API). The API ensures that data is transmitted consistently and efficiently, so the communication does not need to be analyzed to determine the location of specific details like the manufacturer.

Artificial intelligence may analyze the master report of problems and solutions to determine maintenance procedures and schedules aimed at reducing future issues. This analysis helps identify problems that need addressing and assesses their criticality. For example, if an elevator reports a certain number of completed cycles, it may indicate that future maintenance is needed as it approaches a specified threshold. Similarly, if a financial figure such as the average room rate is below expectations, adjustments to the pricing algorithm may be necessary. The average room rate is a component of the financial picture of a hotel.

The system and method may communicate the report to an authority in a format convenient for them. The report may be sparse, containing only key data, or detailed, including past history and information on related elements. The authority may have the option to edit the report, removing certain issues and highlighting others as needed.

In some embodiments, the volume, timing, and length of communications may be of interest to the authority. Therefore, the number of calls, the timing of the calls, the length of the calls, and the purpose of the calls may be tracked and stored. Additional statistics may also be determined and tracked, such as the percentage of communications that are answered. During busy periods, a call to the front desk might go unanswered, which could indicate potential issues such as inadequate staffing or other factors affecting guest satisfaction. Similarly, the time taken to respond to a communication may be tracked. The response time may reflect user satisfaction and may point to issues such as inadequate staffing, poor training, motivational problems, or technical difficulties. Analyzing these communication details over time may help compare current performance with past performance within specific time periods. For example, the average time to answer a call in a given week may be compared to the previous week to assess whether performance is improving or declining. An executive summary may highlight key metrics from the day, such as the percentage of communications answered and the average response time. Raw numbers and percentages compared to previous time periods may also be available. Additionally, the number of calls during a given period may be compared to a previous period for further insights. The analysis data may be formatted into a report and pushed to authorities on a periodic basis.

The communications may also be analyzed by time periods to provide deeper insights. For instance, communication volume by hour may be assessed, and the hour with the highest communication volume may be highlighted. The time period with the most unanswered communications may also be noted. Raw data may be presented alongside the analysis, and particularly relevant data may be highlighted. For example, if two calls were received between noon and 12:59 pm and only one was answered, the answered call percentage would be 50%, which might appear low. However, given the small sample size of two calls, this data might not be particularly significant.

In another aspect, communications for an entire day may be analyzed. Raw numbers such as communications answered, communications not answered, and the total number of communications may be displayed. Average response time and average length of responses may also be listed. For even more detail, a 24-hour analysis may be presented with columns breaking down the number of communications received, the number answered, the number not answered, average response time, and average response length, all segmented by each hour.

Historical analysis of relevant communication data may also be available if desired. Data such as communications answered, communications not answered, and total communications may be displayed for the previous 30 days and the previous 365 days. Averages for metrics such as average wait time for a communication, average response creation time, average number of communications received, average number of responses, average number of communications not responded to, the highest communication hour, and the highest communication day for these periods may also be provided.

The data may be arranged in an easy-to-read format. Key data may be highlighted in a summary form, with more detailed data presented further down the report. The report may be created and distributed automatically to authorities. It may be reformatted periodically by an authority or based on the analysis. For example, if the analysis reveals unexpected changes in data, that information may be automatically highlighted.

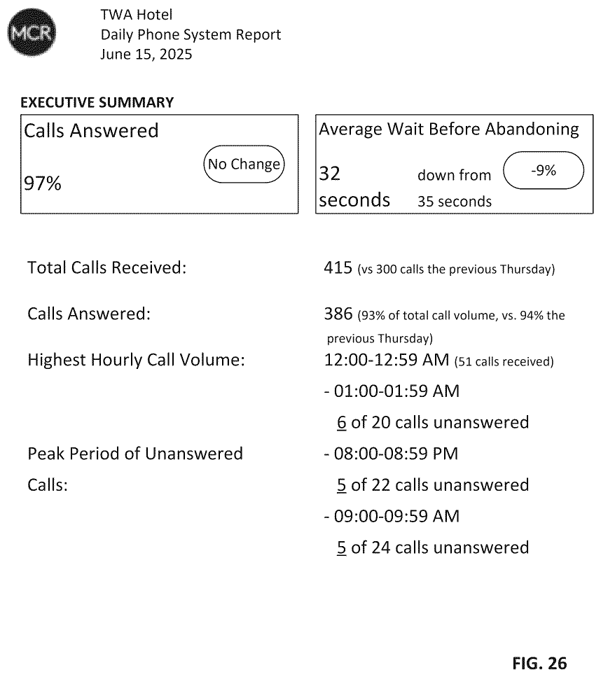

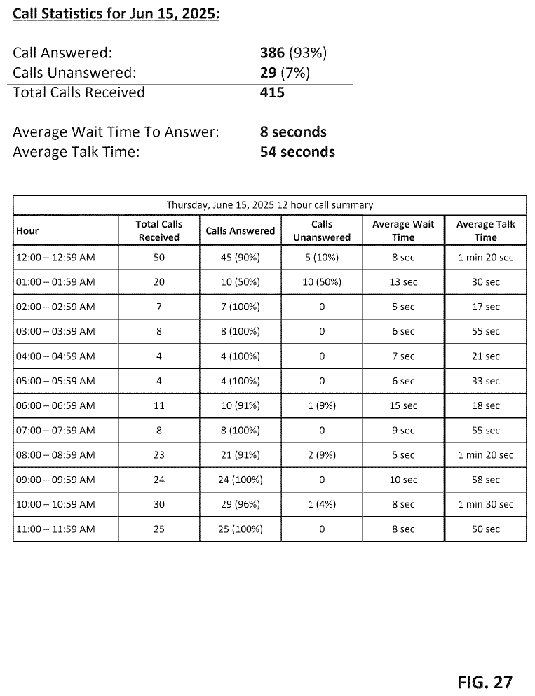

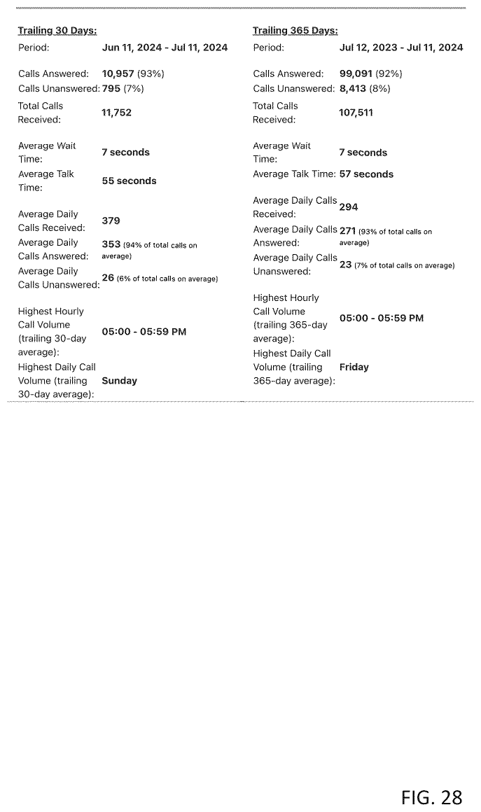

A sample phone report is in FIGS. 26-28. In FIG. 26, a highlighted executive summary may illustrate the percentage of communications that were answered and the average wait time before a communication was abandon. Additional detail may be provided which lists the total calls received, the number of calls answered, the highest hourly call volume and the peak periods of unanswered calls. FIG. 27 may provide additional detail for all calls, broken down by time period. For example, for each hour, a report may list the total communications received, the communications answered, the communications that were unanswered, he average wait time for a communication to receive a response and the average time the communication took. FIG. 28 may illustrate the same relevant statistics for the previous 30 days and the previous 365 days.

### Asset Condition Carryover Report/Front Desk

The system and method may also include a computerized method for tracking the condition of physical assets. For example, a front desk at a hotel may keep a report on the condition of assets in the hotel, or a manufacturing plant may track the condition of machinery. The knowledge from one shift of workers to the next may be enhanced by creating a report on conditions that may be passed from one shift to the next.

At block 400, the system and method may establish a baseline condition for the elements of the physical assets. The purpose of establishing a baseline is to have a reference point to determine if an element of an asset needs attention or is operating within acceptable parameters. The baseline may be created in various ways, as described previously in relation to FIG. 2.

In addition to the baseline creation methods described in relation to FIG. 2, additional resources may be used to establish the baseline for physical asset elements. For example, cameras in a hotel may be used to monitor for theft. Images from these cameras could be analyzed by an artificial intelligence system to establish a baseline. For instance, if a ladder in a pool is expected to remain stationary except during use, the baseline for the ladder may be that it is stationary unless moved. In a manufacturing setting, temperature readings of an element may be used to establish a baseline temperature. Similarly, financial metrics such as revenue from a sundry shop in a hotel may also have a baseline established.

At block 410, the system and method may receive updated condition data for the elements of the physical assets after a certain period. This update aims to determine if the element has returned to an acceptable state or if it requires attention. The updated condition may be an image, a sensor reading, a report from an element, or a financial measure. The time period of the update may also be relevant. For example, revenue from a sundry shop might be measured daily, while the temperature of a machine bearing might be recorded every minute.

At block 420, the system and method may determine if the updated conditions of the elements are materially different from the baseline conditions. The purpose of this determination is to assess if the elements have deviated from acceptable standards or need attention. For example, if a ladder in a pool is missing from an image taken later, it may indicate that the ladder is outside the baseline condition and should be reported. In some cases, a brief removal of the ladder (e.g., 30 seconds) might not be significant, while in other situations, any removal might indicate a problem that should be reported.

Materiality may vary for each element and over different time periods. For example, a slight temperature increase in a train wheel bearing might be critical due to the risk of derailment, while revenue fluctuations from a hotel's sundry shop may be less urgent.

In some embodiments, statistics may be used to determine materiality levels. Standard deviations of data may indicate materiality levels. For example, a temperature reading that deviates by half a standard deviation from the norm may be flagged for reporting. The time period also matters; for example, low sundry sales in the morning might not be concerning, but low sales over a day or week might warrant attention.

At block 430, if the updated conditions of an element are determined to be materially different from the baseline during a given time period, the system and method may add these updated conditions to a report.

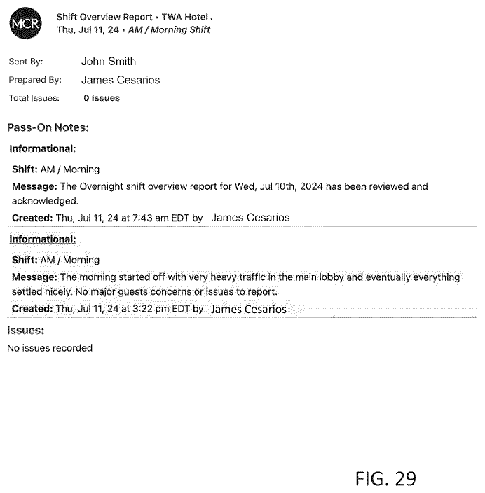

The report may take various forms. In some embodiments, elements may be listed chronologically, with the most recent issues listed first. In other embodiments, elements may be prioritized based on criteria such as urgency or impact. A sample front desk report is illustrated in FIG. 29. The report may include the shift covered, the message about the shift, when it was created and any issues that were addressed or need to be addressed. The report also may indicate that it was received by the subsequent front desk employee.

Determining priority may involve various approaches. For example, priority might be based on the monetary value of the damage, the anticipated cost of bringing the element back to baseline, the degree of danger posed by the deviation, or a supervisor's judgment. Artificial intelligence might also be used to analyze the impact of listed elements on organizational profitability.

Supervisors may edit the report with comments. For example, they may note that a repairman has been called and the expected arrival time, that an item was marked as inoperative, or that an item has been fixed and is operating within its baseline.

Additional details may be included in the report. For instance, the report might display the number of consecutive times an element has appeared on the report, the frequency of its appearance over a period, or previous instances of the element being out of baseline over the past week, month, or year.

Referring again to FIG. 4, at block 440, if the updated conditions of an element are determined not to be materially different from the baseline, the system and method may choose not to add the updated conditions to the report. In other words, if an element is operating according to its baseline, it may not be included in the report. In some embodiments, items that were listed in previous reports may include an indication that the issue has been addressed, and eventually, these elements may no longer appear on the report. Additionally, the solution to the element being outside its baseline may be documented so that future supervisors may see what actions were taken and the associated costs.

The data regarding the elements on the report may be stored in a database for future analysis. For example, historical data might show that a swimming pool turns green if not serviced weekly. While it might be tempting to reduce service frequency to save money, it may become clear that weekly service is necessary to prevent the pool from turning green. Past cost data and time to fix data may also be useful in predicting future maintenance needs and costs. Artificial intelligence may analyze this data, which may be aggregated across multiple assets, such as hotels or manufacturing plants, to provide deeper insights.

In some embodiments, the data on an element may be formatted according to a protocol and communicated to a service provider. For example, if a hotel guest reports that a pool is too cold, the temperature data from the pool may be formatted in a standard way and sent to the pool heater maintenance company. This data might include the heater manufacturer, model, error codes, and the current pool temperature.

Reports from multiple assets may be consolidated into a master report, allowing asset owners to view data from several assets at a glance. The master report may include accumulated solutions and costs. Artificial intelligence may analyze the master report to determine maintenance procedures and schedules aimed at reducing future problems.

At block 450, the system and method may display the report to a supervisor. The report may be automatically delivered to supervisors, so they receive it without having to request it. The report may be sent in a convenient format, such as email, text message, or voice message.

Supervisors may vary depending on the assets, priority levels, and organizational preferences. For example, in a hotel, the front desk attendant might be considered a supervisor and receive the report each time a shift changes. Additionally, if the hotel is part of a group of commonly owned hotels, the owners might also receive the report.

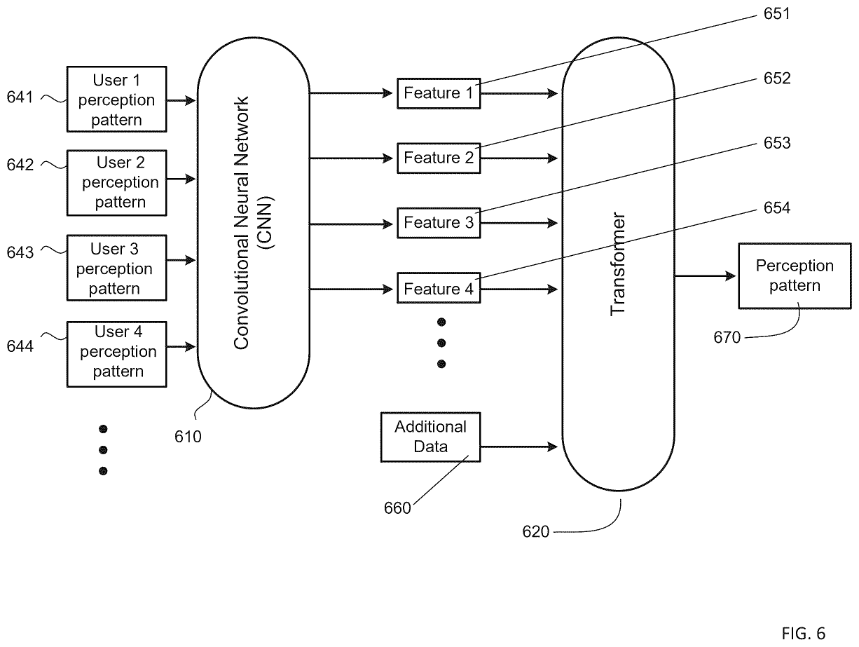

Various learning algorithms may be employed. For instance, as shown in FIG. 6, a convolutional neural network (CNN) and a transformer may be used especially on identifying elements from photos or videos. The CNN may identify features for each user, which may be a set of numbers that may vary based on numerous factors.

The CNN might be trained on millions of past images and could be specifically designed to understand the business being analyzed, using proprietary data from the company. Other learning algorithms, such as a fully connected neural network (FCN), might also be used.

In training, the transformer 620 may process features 651-654 from multiple data sets of a similar type (the outputs of the CNN) along with additional information provided by the asset owner 660 to create a model. Once trained, the transformer may generate predictions for image analysis resolutions 670, which may be available in real-time. The transformer 620 used in this method may be trained on a dataset specifically designed for predicting asset analysis resolutions 670.

The trained model in the transformer 620 will analyze the features of users 644 as well as external information to asset analysis resolutions. The learning algorithm may also assess other relevant information about the analysis.

### Computing Devices

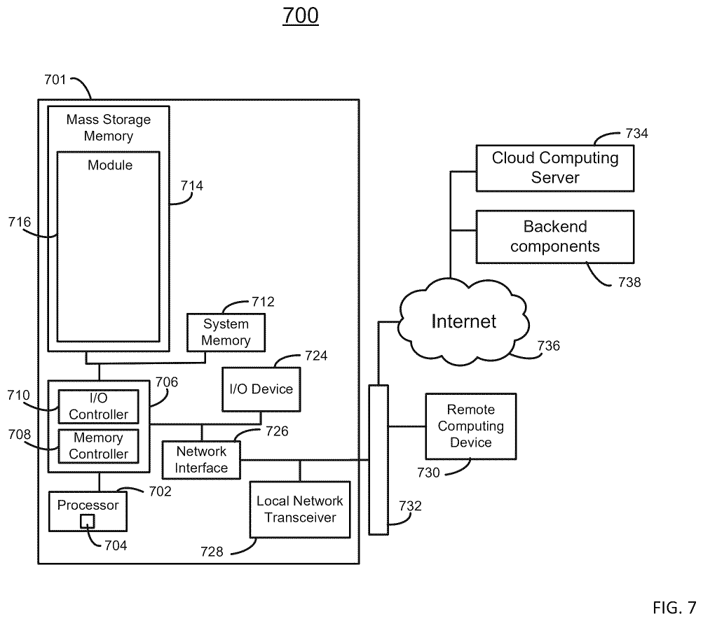

Computing devices are used throughout the method and system. As shown in FIG. 7, the computing device 701 that executes the method may include a processor 702 coupled to an interconnection bus. The processor 702 may include a register set or register space 704, which is depicted in FIG. 7 as being entirely on-chip, but which could alternatively be located entirely or partially off-chip and directly connected to the processor 702 via dedicated electrical connections and/or the interconnection bus. The processor 702 may be any suitable processor, processing unit, or microprocessor. Although not shown in FIG. 7, the computing device 701 may be a multi-processor device, including one or more additional processors that are identical or similar to the processor 702 and communicatively coupled to the interconnection bus.

The processor 702 may be coupled to a chipset 706, which includes a memory controller 708 and a peripheral input/output (I/O) controller 710. A chipset typically provides I/O and memory management functions, as well as a variety of general-purpose and/or special-purpose registers, timers, etc., accessible or used by one or more processors coupled to the chipset 706. The memory controller 708 enables the processor 702 (or processors, if multiple) to access system memory 712 and mass storage memory 714. The mass storage memory 714 may include an in-memory cache (e.g., a cache within the memory 712) or an on-disk cache (e.g., a cache within the mass storage memory 714).

The system memory 712 may include any type of volatile and/or non-volatile memory, such as static random access memory (SRAM), dynamic random access memory (DRAM), flash memory, read-only memory (ROM), etc. The mass storage memory 714 may include various types of mass storage devices, such as a hard disk drive, an optical drive, a tape storage device, solid-state memory (e.g., flash memory, RAM), magnetic memory (e.g., a hard drive), or other suitable storage. Modules, blocks, functions, operations, procedures, routines, steps, and methods refer to tangible computer program logic or executable instructions providing functionality to the computing device 401, systems, and methods described herein. Such entities may be implemented in hardware, firmware, and/or software.

Program modules and routines may be stored in mass storage memory 714, loaded into system memory 712, and executed by a processor 702 or provided from computer program products stored in tangible computer-readable storage media (e.g., RAM, hard disk, optical/magnetic media).

The peripheral I/O controller 710 enables the processor 702 to communicate with a peripheral I/O device 724, a network interface 726, and a local network transceiver 728 via the peripheral I/O bus. The I/O device 724 may be any type of I/O device, such as a keyboard, display (e.g., LCD, CRT), navigation device (e.g., mouse, trackball, capacitive touch pad, joystick), etc. The I/O device 724 may interact with the module 716 to receive data from the transceiver 728, send data to system components, and perform operations related to the described methods. The local network transceiver 728 supports wireless data transmission protocols such as Wi-Fi, Bluetooth, Infrared, cellular, or other protocols. Some embodiments may support multiple wireless protocols simultaneously through a software-defined radio with downloadable instructions. The computing device 701 may periodically poll for visible wireless network transmitters while supporting normal wireless traffic. The network interface 726 might include an Ethernet device, ATM device, 802.11 wireless interface, DSL modem, cable modem, cellular modem, etc., enabling communication with other computer systems with similar elements.

The memory controller 708 and I/O controller 710, depicted as separate blocks in FIG. 7, may be integrated within a single integrated circuit or implemented using multiple integrated circuits. The computing environment 700 may also involve implementing module 716 on a remote computing device 730, which communicates with the computing device 701 over an Ethernet link 732. In some cases, module 716 may be retrieved from a cloud computing server 734 via the Internet 736 and linked with the computing device 701. Module 716 may include software components such as artificial intelligence software and document creation software or a Java® applet executing within a Java® Virtual Machine (JVM) environment. It may also be a “plug-in” for a web browser on the computing devices 701 and 730. In some embodiments, module 716 may communicate with back-end components 738 via the Internet 736.

The system 700 may include various types of networks, such as LAN, MAN, WAN, mobile, wired or wireless, private, or virtual private networks. While FIG. 7 shows only one remote computing device 730 for clarity, the system 700 may support multiple client computers.

Certain embodiments may include logic or components, modules, blocks, or mechanisms. Modules and method blocks may be software modules (e.g., code or instructions on a machine-readable medium or in a transmission signal executed by a processor) or hardware modules. A hardware module is a tangible unit capable of performing certain operations and may be configured in various ways. For example, a hardware module may include dedicated circuitry or logic permanently configured (e.g., as an FPGA or ASIC) to perform specific operations. Alternatively, it may include programmable logic (e.g., within a processor) temporarily configured by software. The choice between mechanical, dedicated, or programmable hardware modules may depend on cost and time considerations.

The term “hardware module” encompasses tangible entities physically constructed, permanently configured (e.g., hardwired), or temporarily configured (e.g., programmed) to operate in a certain manner. A “hardware-implemented module” may refer to a hardware module. In cases where hardware modules are temporarily configured (e.g., programmed), not all hardware modules need to be instantiated simultaneously. For example, a processor configured by software may act as different hardware modules at different times.

Hardware modules may communicate with each other, and where multiple modules exist simultaneously, communication may occur through signal transmission over circuits and buses. When modules are instantiated at different times, communication may involve storing and retrieving information in accessible memory structures. Hardware modules may also interact with input or output devices and operate on resources (e.g., collections of information).

The various operations of example methods described herein may be performed by one or more processors temporarily or permanently configured to perform relevant operations. Such processors may constitute processor-implemented modules. The methods or routines described may be at least partially processor-implemented, with operations distributed across one or more processors, which may be located in a single or multiple locations. The processors may operate in a “cloud computing” environment or as a “software as a service” (SaaS), with operations accessible via a network and interfaces (e.g., APIs).

The performance of operations may be distributed across multiple machines, which may be located in a single or various geographic locations. Portions of this specification may describe algorithms or symbolic representations of operations on data stored as bits or binary digital signals within machine memory. These algorithms or representations convey processing techniques, typically involving physical manipulation of quantities such as electrical, magnetic, or optical signals. Terms like “data,” “content,” “bits,” “values,” and similar labels may refer to physical quantities.

Unless stated otherwise, terms like “processing,” “computing,” “calculating,” “determining,” “presenting,” or “displaying” refer to actions or processes performed by a machine (e.g., a computer) that manipulates or transforms data represented as physical quantities within one or more memories, registers, or other components.

References to “embodiments,” “some embodiments,” “an embodiment,” or “teachings” indicate that a particular element or feature described is included in at least one embodiment. The phrase “in some embodiments” may not always refer to the same embodiment.

The terms “coupled” and “connected” may indicate direct physical or electrical contact or indirect cooperation or interaction. The embodiments are not limited to these contexts. Figures illustrate preferred embodiments for clarity. Alternatives may be employed without departing from the principles described. Upon reviewing this disclosure, additional structural and functional designs may be appreciated. The disclosed embodiments may not be limited to the exact construction and components described, and various modifications and variations may be made without departing from the spirit and scope defined in the appended claims.

1. A computerized method of tracking conditions of physical assets comprising:
establishing a baseline condition of elements of the physical assets;
receiving updated condition for the elements of the physical assets after a period of time;
determining if the updated conditions of the elements of the physical assets are materially different than the baseline conditions of the elements of the physical assets;
in response to the updated conditions of one of the elements being determined to be materially different than the baseline conditions;
adding the updated conditions of one of the element determined to be materially different than the baseline conditions to a report;
in response to the updated conditions of one of the element being determined not to be materially different than the baseline, not adding the updated conditions of the element determined to be materially different than the baseline conditions to a report; and
displaying the report to a supervisor.

2. The method of claim 1, wherein establishing a baseline comprises:
collecting data over a significant period of time;
utilizing artificial intelligence on an analysis system to analyze the data over time to determine patterns; and
setting a baseline for a time period based on the analysis.

3. The computerized method of claim 1, wherein the report includes the time of the updated conditions were received and the manner of receiving the communication.

4. The computerized method of claim 1, wherein the report may be edited with comments by the supervisor.

5. The computerized method of claim 1, wherein the number of consecutive times the element has been on the report is displayed on the report.

6. The computerized method of claim 1, wherein the number of times the element has been displayed on the report during a period of time is displayed.

7. The computerized method of claim 1, wherein previous reports regarding the element determined to be materially different than the baseline conditions during a period of time are displayed.

8. The computerized method of claim 1, wherein data is added to a database to create a baseline for the element.

9. The computerized method of claim 1, wherein the data on the element is formatted according to a protocol for the element and is communicated to a service provider for the element.

10. The computerized method of claim 8, wherein a follow up task is added for the element.

11. The computerized method of claim 8, wherein a solution to place the element back into the baseline condition is added to the database.

12. The computerized method of claim 8, wherein the report includes the cost to place the element back into baseline condition.

13. The computerized method of claim 8, wherein reports for several lodgings are accumulated to create a master report.

14. The computerized method of claim 8, wherein the master report includes accumulated solutions and the accumulated costs.

15. The computerized method of claim 13, wherein artificial intelligence analyzes the master report of problems and solutions and determines maintenance procedures and schedules to reduce future problems.

16. A computer system comprising a processor, a memory and an input/output circuit, the processor being physically configured according to computer executable instructions, the computer executable instructions comprising instructions for:
establishing a baseline condition of elements of the physical assets;
receiving updated condition for the elements of the physical assets after a period of time;
determining if the updated conditions of the elements of the physical assets are materially different than the baseline conditions of the elements of the physical assets;
in response to the updated conditions of one of the elements being determined to be materially different than the baseline conditions;
adding the updated conditions of one of the element determined to be materially different than the baseline conditions to a report;
in response to the updated conditions of one of the element being determined not to be materially different than the baseline, not adding the updated conditions of the element determined to be materially different than the baseline conditions to a report; and
displaying the report to a supervisor.

17. The computer system of claim 16, wherein the number of consecutive times the element has been on the report is displayed on the report.

18. The computer system of claim 16, wherein the number of times the element has been displayed on the report during a period of time is displayed.

19. The computer system of claim 16, wherein the data on the element is formatted according to a protocol for the element and is communicated to a service provider for the element.

20. The computer system of claim 16, wherein artificial intelligence analyzes the master report of problems and solutions and determines maintenance procedures and schedules to reduce future problems.
